(19) United States
(12) Patent Application Publication
(10) Pub. No.: US 2011/0102718 A1
(43) Pub. Date: May 5, 2011

(54) LIQUID CRYSTAL DISPLAY APPARATUS

(75) Inventors: Toshiaki YOSHIHARA, Kawasaki (JP); Yoshihisa Kurosaki, Kawasaki (JP); Takuto Kato, Kawasaki (JP)

(73) Assignee: Fujitsu Limited, Kawasaki-shi (JP)

(21) Appl. No.: 12/912,002

(22) Filed: Oct. 26, 2010

(30) Foreign Application Priority Data
Oct. 30, 2009 (JP) 2009-251448

(51) Int. Cl. G02F 1/1335

(52) U.S. Cl. 349/113

(57) ABSTRACT

A liquid crystal display apparatus includes a plurality of pixels. Each of the pixels includes a first liquid crystal display device including a first region for reflecting a light of a first reflection wavelength band and a second region for reflecting a light of a second reflection wavelength band, and a second liquid crystal display device including a third region for reflecting a light of a third reflection wavelength band and a fourth region for reflecting a light of a fourth reflection wavelength band, the second liquid crystal display device being stacked over the first liquid crystal display device.

### CROSS-REFERENCE TO RELATED APPLICATION

This application is based upon and claims the benefit of priority from the prior Japanese Patent Application No. 2009-251448 filed on Oct. 30, 2009, the entire contents of which are incorporated herein by reference.

### FIELD

The embodiments discussed herein are related to a liquid crystal display apparatus.

### BACKGROUND

In recent years, several companies and universities have intensely advanced the development of electronic paper that utilizes liquid crystal technology that provides a property of semipermanently holding display contents. The electronic paper is expected to be applied to various types of portable devices, such as an electronic book, a sub-display of a mobile terminal, and a display unit of an IC card. One of efficient display techniques used for the electronic paper is applied to a display device that uses a liquid crystal composition that exhibits a cholesteric phase. The liquid crystal composition that exhibits the cholesteric phase is hereinafter referred to as cholesteric liquid crystal. The cholesteric liquid crystal has a property of semipermanently holding display contents (memory property) and has clear color display characteristics, high contrast characteristics, and high resolution characteristics.

A full-color liquid crystal display device 150 using the cholesteric liquid crystal will be described with reference to FIG. 15. FIG. 15 is a cross-sectional view illustrating the liquid crystal display device 150 in which the cholesteric liquid crystal is utilized to provide full-color display. With reference to FIG. 15, the liquid crystal display device 150 has a three-layered structure in which a blue (B) display section 120, a green (G) display section 110, and a red (R) display section 130 are stacked in sequence beginning with a display surface of the device. In FIG. 15, an upper substrate functions as the display surface, and external light (indicated by a solid arrow) enters the display surface from above the substrate. Furthermore, an observer's eye and a viewing direction (indicated by a dashed arrow in FIG. 15) are schematically illustrated above the substrate.

The blue display section 120 has a blue (B) liquid crystal layer 121 enclosed between a pair of an upper substrate 124 and a lower substrate 125 and has a B pulse voltage source 122 which applies a predetermined pulse voltage to the B liquid crystal layer 121. The green display section 110 has a green (G) liquid crystal layer 111 enclosed between a pair of an upper substrate 114 and a lower substrate 115 and has a G pulse voltage source 112 which applies a predetermined pulse voltage to the G liquid crystal layer 111. The red display section 130 has a red (R) liquid crystal layer 131 enclosed between a pair of an upper substrate 134 and a lower substrate 135 and has an R pulse voltage source 132 which applies a predetermined pulse voltage to the R liquid crystal layer 131. Furthermore, a visible light absorption layer 12 is provided on the back surface of the lower substrate 135 of the R display section 130, thereby absorbing light.

The cholesteric liquid crystal controls reflection of light on the basis of the orientation state of helically twisted liquid crystal molecules in each of the display sections that is stacked to form the three-layered structure. Specifically, in the cholesteric liquid crystal, electric field intensity that is applied to the liquid crystal is controlled, thereby transferring the orientation state of the liquid crystal molecules to any of a planar state, a focal conic state, and an intermediate state between the planar state and the focal conic state. The cholesteric liquid crystal controls a proportion of reflected light to transmitted light depending on the state of the liquid crystal molecules to change the intensity of reflected light.

The liquid crystal molecules in the planar state each sequentially rotate in the thickness direction of the substrate to form a helical structure, and the helical axis of the helical structure is substantially vertical to the surface of the substrate. In the planar state, light having a predetermined wavelength corresponding to the helical pitches of the liquid crystal molecules is selectively reflected from the liquid crystal layer. The liquid crystal molecules in the focal conic state each sequentially rotate in the in-plane direction of the substrate to form a helical structure, and the helical axis of the helical structure is substantially parallel to the surface of the substrate. In the focal conic state, the selectivity for a reflection wavelength is excluded in the B liquid crystal layer, and the B liquid crystal layer transmits most of the incident light.

As described above, the cholesteric liquid crystal is used to form the three-layered structure by stacking the individual liquid crystal display sections that selectively reflect light beams of red, green, and blue, and reflection of light is controlled on the basis of the orientation state of the helically twisted liquid crystal molecules. The cholesteric liquid crystal helps display be performed without power consumption except when contents are being rewritten on a screen, thereby performing full-color display in which the memory properties are provided.

A liquid crystal display device as a full-color liquid crystal display device using the cholesteric liquid crystal is well-known. In the disclosure, the cholesteric liquid crystal is enclosed such that a single layer has selectivity for three types of reflection wavelengths, and two cholesteric liquid crystal devices are stacked to form a two-layered structure.

The followings are reference document.
[Document 1] Japanese Laid-open Patent Publication No. 10-90726

### SUMMARY

According to an aspect of the embodiment, a liquid crystal display apparatus includes a plurality of pixels, each of the pixels including: a first liquid crystal display device including a first region for reflecting a light of a first reflection wavelength band and a second region for reflecting a light of a second reflection wavelength band, and a second liquid crystal display device including a third region for reflecting a light of a third reflection wavelength band and a fourth region for reflecting a light of a fourth reflection wavelength band, the second liquid crystal display device being stacked over the first liquid crystal display device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 schematically illustrates an example of the configuration of a liquid crystal display apparatus according to a first embodiment;

FIG. 2 illustrates an example of liquid crystal display devices that form a two-layered structure;

FIG. 3 illustrates an example of the cross-sectional configuration of the liquid crystal display device;

FIG. 4A illustrates a mechanism of display in a liquid crystal display apparatus using cholesteric liquid crystal;

FIG. 4B illustrates another mechanism of the display in the liquid crystal display apparatus using the cholesteric liquid crystal;

FIG. 5 illustrates an example of reflectance spectrums of red, green, and blue light beams;

FIG. 6 illustrates an example of voltage-reflectance characteristics;

FIG. 7 illustrates an example of the relationship between pulse number and brightness;

FIG. 8 illustrates production of the liquid crystal display device;

FIG. 9 schematically illustrates an example of the configuration of a liquid crystal display apparatus according to a second embodiment;

FIG. 10 illustrates an example of the cross-sectional configuration of a liquid crystal display device;

FIG. 11 illustrates production of the liquid crystal display device;

FIG. 12A illustrates an example of a liquid crystal display device having a two-layered structure;

FIG. 12B illustrates another example of the liquid crystal display device having the two-layered structure;

FIG. 12C illustrates another example of the liquid crystal display device having the two-layered structure;

FIG. 13A illustrates an example of a liquid crystal display device having a two-layered structure;

FIG. 13B illustrates another example of the liquid crystal display device having the two-layered structure;

FIG. 13C illustrates another example of the liquid crystal display device having the two-layered structure;

FIG. 14 illustrates production of the liquid crystal display device; and

FIG. 15 is a cross-sectional view illustrating an existing full-color liquid crystal display using cholesteric liquid crystal.

### DESCRIPTION OF EMBODIMENTS

Embodiments of a liquid crystal display apparatus according to an aspect of the invention will be described in detail with reference to the accompanying drawings.

### First Embodiment

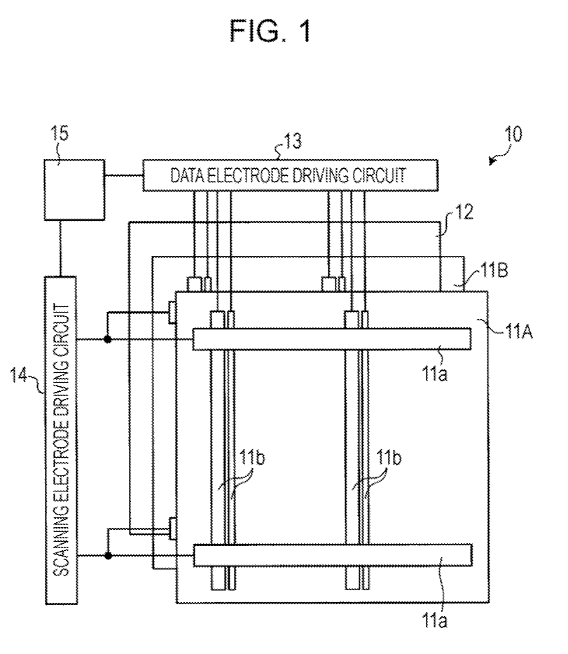

The configuration of a liquid crystal display apparatus 10 will be described with reference to FIG. 1. FIG. 1 schematically illustrates an example of the configuration of the liquid crystal display apparatus 10 according to a first embodiment. With reference to FIG. 1, the liquid crystal display apparatus 10 has a first layered liquid crystal display device 11A, a second layered liquid crystal display device 11B, a scanning electrode 11a, a data electrode 11b, a visible light absorption layer 12, a data electrode driving circuit 13, a scanning electrode driving circuit 14, and a control circuit 15.

In the liquid crystal display apparatus 10, a two-layered structure in which the display devices are stacked is provided between substrates in the manner of a sandwich, the display devices each having a liquid crystal material that is enclosed therein and that reflects light having a predetermined wavelength. Specifically, in the liquid crystal display apparatus 10, the two display devices (the first layered liquid crystal display device 11A and the second layered liquid crystal display device 11B) are stacked, and the liquid crystal material that is enclosed in one of the display devices reflects light so as to have selectivity for two types of reflection wavelengths. The liquid crystal display devices exhibit the selectivity for any two types of the reflection wavelengths selected from red, green, and blue. In the selectivity for the reflection wavelengths in the liquid crystal devices, one liquid crystal display device exhibits selectivity for one wavelength for which selectivity is not exhibited in another liquid crystal display device, such a wavelength being selected from three types of the wavelengths of red, green, and blue. In other words, each of the liquid crystal display devices exhibits selectivity for one type of the reflection wavelengths selected from the three colors, and the two liquid crystal display devices individually exhibit selectivity for the other two types of reflection wavelengths. In addition, in order to absorb light, the visible light absorption layer 12 is provided at the bottom of the display devices that are stacked to form the two-layered structure.

The liquid crystal display apparatus 10 includes the first layered liquid crystal display device 11A and the second layered liquid crystal display device 11B that are stacked in sequence. Cholesteric liquid crystal is used as the liquid crystal material in each of the first and second layered liquid crystal display devices 11A and 11B.

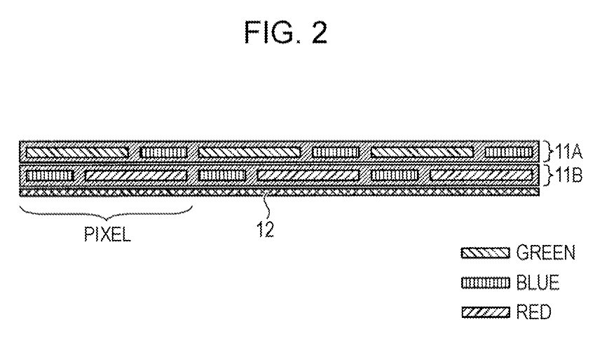

An example of the liquid crystal display devices that form the two-layered structure will be described with reference to FIG. 2. FIG. 2 illustrates an example of the liquid crystal display devices that form the two-layered structure. For example, individual liquid crystal materials that selectively reflect light beams of green and blue are separately enclosed in the first layered liquid crystal display device 11A. Furthermore, individual liquid crystal materials that selectively reflect light beams of red and blue are separately enclosed in the second layered liquid crystal display device 11B.

In the liquid crystal display apparatus 10, each of the display devices, which is stacked to form the two-layered structure, has pixel areas corresponding to the selectivity for the reflection wavelength that is different between the liquid crystal display devices. In addition, such pixel areas have sizes twice as large as those of pixel areas corresponding to the selectivity for the reflection wavelength that is employed in common in the liquid crystal display devices. Specifically, the liquid crystal materials that exhibit selectivity for the two types of the reflection wavelengths are individually enclosed in the two display devices, and the liquid crystal material that exhibits the selectivity for one type of the reflection wavelengths is enclosed in common in each of the display devices. With reference to FIG. 2, in the first layered liquid crystal display device 11A, each of the pixel areas of a green liquid crystal material that is different between the display devices has a size approximately twice as large as that of the pixel area of a blue liquid crystal material that is included in common in the display devices.

The liquid crystal display apparatus 10 has the two-layered structure including liquid crystal display devices as described above. The reflection intensity of each of the first layered liquid crystal display device 11A and the second layered liquid crystal display device 11B is controlled by an electric field or the like, thereby providing color display by the two-layered structure which has the reduced number of layers relative to the existing three-layered structure. Accordingly, the color display is capable of being provided by the two-layered structure, and production costs are also capable of being decreased. Furthermore, the number of drivers used for actuation of the liquid crystal display devices and types of liquid crystal in the layered display devices are capable of being reduced as compared with a liquid crystal display apparatus having a two-layered structure in which one layer exhibits the selectivity for three types of the reflection wavelengths.

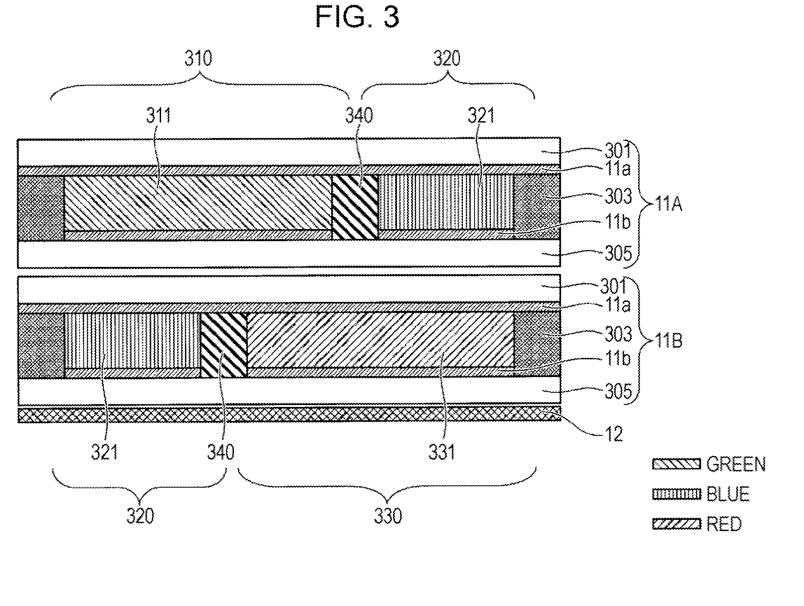

The liquid crystal display devices will be described in detail with reference to FIG. 3. FIG. 3 illustrates an example of the cross-sectional configurations of the liquid crystal display devices. The first layered liquid crystal display device 11A has an upper substrate 301 and a lower substrate 305 and has the scanning electrodes 11a, the data electrodes 11b, and sealing members 303. The scanning electrodes 11a and the data electrodes 11b are provided between the upper substrate 301 and the lower substrate 305 so as to intersect and face each other. The sealing members 303 are provided so as to be applied to the peripheries of the upper substrate 301 and the lower substrate 305. Furthermore, the first layered liquid crystal display device 11A has a G display section 310 and a B display section 320, the G display section 310 including a G liquid crystal layer 311 that reflects green light in a planar state, and the B display section 320 including a B liquid crystal layer 321 that reflects blue light in the planar state. Moreover, the first layered liquid crystal display device 11A has a separation wall 340 that separates the G liquid crystal layer 311 from the B liquid crystal layer 321.

The second layered liquid crystal display device 11B similarly has the upper substrate 301 and the lower substrate 305 and has the scanning electrodes 11a, the data electrodes 11b, and the sealing members 303. The scanning electrodes 11a and the data electrodes 11b are provided between the upper substrate 301 and the lower substrate 305 so as to intersect and face each other. The sealing members 303 are provided so as to be applied to the peripheries of the upper substrate 301 and the lower substrate 305. Furthermore, the second layered liquid crystal display device 11B has the B display section 320 and an R display section 330, the B display section 320 including the B liquid crystal layer 321 that reflects the blue light in a planar state, and the R display section 330 including an R liquid crystal layer 331 that reflects red light in the planar state. Moreover, the second layered liquid crystal display device 11B has a separation wall 340 that separates the B liquid crystal layer 321 from the R liquid crystal layer 331.

The upper substrate 301 and the lower substrate 305 are required to have translucency. Two polycarbonate (PC) film substrates are used as the upper substrate 301 and the lower substrate 305, the PC film substrates each being prepared so as to have a length of 10 cm and a width of 8 cm. A glass substrate or a film substrate such as a polyethylene terephthalate (PET) film is capable of being used in place of the PC substrate. In the embodiment, although each of the upper substrate 301 and the lower substrate 305 has translucency, a substrate provided at the lowest portion may not be translucent.

The visible light absorption layer 12 is provided on an outer surface (rear surface) of the lower substrate 305 which is included in the second layered liquid crystal display device 11b and which is positioned at the lowest portion. Accordingly, in cases where liquid crystal layers corresponding to colors of B, G, and R are all in focal conic state, black is displayed on a display screen of the liquid crystal display apparatus. Meanwhile, the visible light absorption layer 12 may be provided, where appropriate.

The G display section 310 has a pair of the upper and lower substrates that are disposed so as to face each other and has the G liquid crystal layer 311 enclosed therebetween. The G liquid crystal layer 311 has G cholesteric liquid crystal that is prepared so as to selectively reflect green light. The B display section 320 has a pair of the upper and lower substrates that are disposed so as to face each other and has the B liquid crystal layer 321 enclosed therebetween.

The B liquid crystal layer 321 has B cholesteric liquid crystal that is prepared so as to selectively reflect blue light. Similarly, the R display section 330 has a pair of the upper and lower substrates that are disposed so as to face each other and has the R liquid crystal layer 331 enclosed therebetween. The R liquid crystal layer 331 has R cholesteric liquid crystal that is prepared so as to selectively reflect red light.

A liquid crystal composition will be hereinafter described in detail. A liquid crystal composition contained in the liquid crystal layer is the cholesteric liquid crystal in which a chiral agent is added to a nematic liquid crystal composite in an amount in the range from 10 to 40 wt %. An additive amount of the chiral agent is determined on the basis that the total amount of the nematic liquid crystal composite and the chiral agent is 100 wt %. The nematic liquid crystal to be used may include various types of the existing nematic liquid crystal.

Preferably, refractive index anisotropy (Δn) is in the range from 0.18 to 0.24. In cases where the refractive index anisotropy (Δn) is lower than the range from 0.18 to 0.24, reflectance in the planar state is decreased. In cases where the refractive index anisotropy (Δn) is larger than the range from 0.18 to 0.24, scattering reflection in the focal conic state is increased, and viscosity is also increased, thereby decreasing response speed.

In addition, the liquid crystal layer has a thickness in the range from 3 to 6 μm. In cases where the thickness is lower than such a range, reflectance in the planar state is decreased. In cases where the thickness is larger than such a range, a driving voltage is excessively increased. Preferably, the dielectric constant anisotropy (Δ∈) is in the range from 10 to 40. In cases where the dielectric constant anisotropy is lower than such a range, the driving voltage is increased. In cases where the dielectric constant anisotropy is larger than such a range, viscosity is increased, thereby decreasing response speed. Preferably, in the liquid crystal display apparatus 10 according to the first embodiment, the Δ∈ value of the B liquid crystal material is configured so as to be the largest, and the Δ∈ value of the R liquid crystal material is configured so as to be the lowest, and the Δ∈ value of the G liquid crystal material is configured so as to be intermediate between the Δ∈ values of the B liquid crystal material and the R liquid crystal material. A driving voltage for the liquid crystal material corresponding to each color is also capable of being adjusted in a driving side, and therefore the Δ∈ value may be adjusted where appropriate.

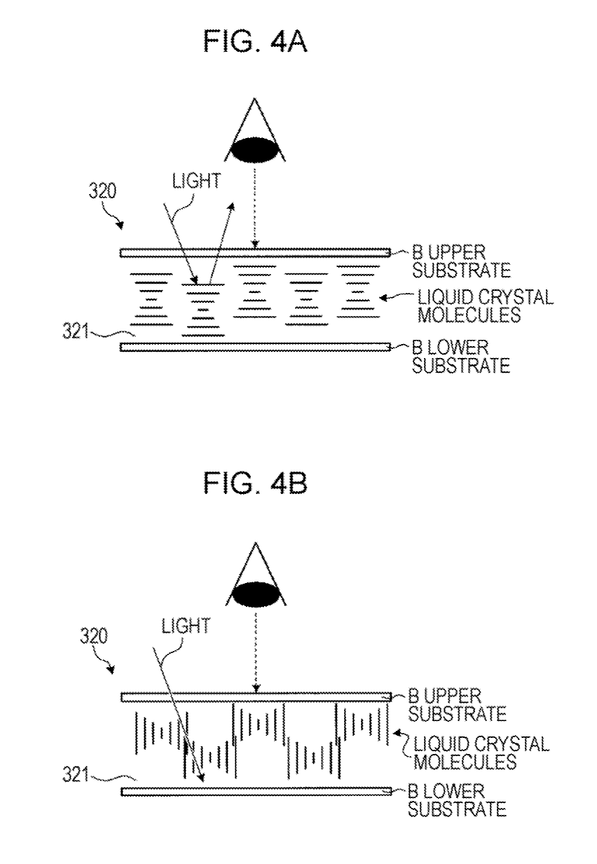

A mechanism of display in the liquid crystal display device using the cholesteric liquid crystal will be described with reference to FIGS. 4A and 4B. FIGS. 4A and 4B each illustrate the mechanism of the display in the liquid crystal display using the cholesteric liquid crystal. FIG. 4A illustrates the B liquid crystal layer 321 of the B display section 320 in which the liquid crystal molecules of the cholesteric liquid crystal are oriented so as to be in the planar state. As illustrated in FIG. 4A, the liquid crystal molecules in the planar state each sequentially rotate in the thickness direction of the substrate to form a helical structure, and the helical axis of the helical structure is substantially vertical to the surface of the substrate.

In the planar state, the liquid crystal layer selectively reflects light having a predetermined wavelength corresponding to the helical pitch of each of the liquid crystal molecules. For example, assuming that an average refractive index is n and that the helical pitch is p, a wavelength λ which enables the maximum reflection is obtained by a formula of λ=n·p. Accordingly, in order to selectively reflect blue light from the B liquid crystal layer 321 of the B display section 320 in the planar state, for example, the average refractive index n and the helical pitch p are determined so as to satisfy the relationship of λ=480 nm. The average refractive index n is capable of being adjusted by selecting the liquid crystal material and the chiral agent, and the helical pitch p is capable of being adjusted by adjusting a content rate of the chiral agent.

FIG. 4B illustrates the B liquid crystal layer 321 of the B display section 320 in which the liquid crystal molecules of the cholesteric liquid crystal are oriented so as to be in the focal conic state. As illustrated in FIG. 4B, the liquid crystal molecules in the focal conic state each sequentially rotate in the in-plane direction of the substrate to form a helical structure, and the helical axis of the helical structure is substantially parallel to the surface of the substrate. In the focal conic state, the selectivity for the reflection wavelength is excluded in the B liquid crystal layer 321, and the B liquid crystal layer 321 transmits most of the incident light. Transmitted light is absorbed by a light absorption layer 12 provided on the rear surface of the lower substrate 305 of the R display section 330, thereby enabling a dark (black) color to be displayed.

In an intermediate state between the planar state and the focal conic state, a proportion of the reflected light to the transmitted light is capable of being adjusted depending on a condition thereof, and therefore the intensity of the reflected light is capable of being changed. As described above, in the cholesteric liquid crystal, reflectance of light is capable of being controlled on the basis of the orientation state of the helically twisted liquid crystal molecules.

As in the case of the B liquid crystal layer 321, the cholesteric liquid crystal that selectively reflects green light and red light in the planar state, is enclosed in the G liquid crystal layer 311 and the R liquid crystal layer 331 to manufacture the liquid crystal display devices in full color, respectively. As described above, the liquid crystal display devices in which the cholesteric liquid crystal is used to selectively reflect red, green, and blue light are stacked, so that the color display is performed without power consumption except when contents are being rewritten on a screen, thereby performing full-color display in which the memory properties are provided.

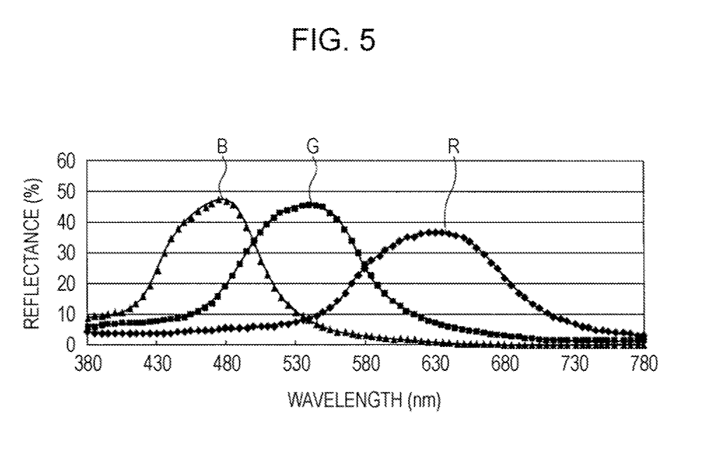

Optical rotation in each of the display sections 310, 320, and 330 will be described with reference to FIG. 5. FIG. 5 illustrates an example of reflectance spectrums of red, green, and blue light beams. In a configuration in which the G display section 310, the B display section 320, and the R display section 330 are stacked, the optical rotation in the G liquid crystal layer 311 in the planar state is configured so as to be different from the optical rotation in the B and R liquid crystal layers 321 and 331. Accordingly, in regions in which the reflectance spectrums of blue and green light beams are overlapped and in which the reflectance spectrums of green and red light beams are overlapped as illustrated in FIG. 5, right-handed circularly polarized light is reflected from the B liquid crystal layer 321 and the R liquid crystal layer 331, and left-handed circularly polarized light is reflected from the G liquid crystal layer 311, for example. Consequently, the loss of reflected light is capable of being reduced, and the brightness of the screen of the liquid crystal display apparatus is also capable of being improved.

Returning to FIG. 1, a plurality of the strip-shaped scanning electrodes 11a are formed in parallel on the upper substrate 301 of each of the layered display devices at the side of the liquid crystal layer, the scanning electrodes 11a extending in a horizontal direction in FIG. 1. In addition, a plurality of the strip-shaped data electrodes 11b are formed in parallel on the lower substrate 305 of each of the layered display devices at the side of the liquid crystal layer, the data electrodes 11b extending in a vertical direction in FIG. 1. Furthermore, in the liquid crystal display apparatus 10, in order to display a Quarter Video Graphics Array (QVGA) of 320×240 dots, transparent electrodes are patterned to form a plurality of the scanning electrodes 11a and the data electrodes 11b of a 0.24 mm pitch in the form of a strip. For example, the data electrodes 11b are configured so as to have widths of 0.07 mm, interelectrode gaps of 0.015 mm, other widths of 0.14 mm, and other interelectrode gaps of 0.015 mm, thereby providing a 0.24 mm pitch, and the scanning electrodes 11a are configured so as to have widths of 0.225 mm and interelectrode gaps of 0.015 mm, thereby providing a 0.24 mm pitch.

As illustrated in FIG. 1, in cases where electrode-formed surfaces of the upper and lower substrates are viewed in a normal direction, the scanning electrodes 11a and the data electrodes 11b are disposed so as to intersect and face each other. Each region in which both electrodes intersect is a pixel. Pixels are arranged in the manner of a matrix to form a display screen.

Examples of the material of each of the scanning electrodes 11a and the data electrodes 11b typically include indium tin oxide (ITO) but also include the materials of a transparent conductive film such as an indium zinc oxide (IZO) film, a metallic electrode such as an aluminum or silicon electrode, and a photoconductive film such as an amorphous silicon or bismuth silicon oxide (BSO) film.

Preferably, surfaces of the scanning electrodes 11a and the data electrodes 11b are coated with insulating films and orientation films (each not illustrated) that serve as functional films, the orientation film regulating the orientation of the liquid crystal molecules. The insulating films have functions that prevent short circuits between the electrodes and that serve as gas barrier layers to enhance the reliability of the liquid crystal display apparatus. Examples of a material of the orientation films include an organic film such as a polyimid resin, a polyamide-imide resin, a polyetherimide resin, a polyvinyl butyral resin, or an acrylate resin and include an inorganic material such as a silicon oxide or an aluminum oxide. An orientation film is applied to (coats) the entire surface of the substrate overlying the electrodes. The orientation film may also function as a thin insulating film. A surface of the orientation film may be subjected to rubbing, where appropriate.

The liquid crystal display apparatus 10 has the sealing members 303 applied to the peripheries of the upper and lower substrates and has the separation wall 340 provided inside the sealing members 303, thereby enclosing each of the liquid crystal layers between the substrates. In the liquid crystal display apparatus 10, two types of the liquid crystal materials are enclosed in one liquid crystal display device, and therefore a structure by which the two liquid crystal layers are separated from each other is provided inside the sealing members 303 as illustrated in FIG. 3. Such a structure is preferably provided at a position of the interelectrode gap. Such a structure is capable of being manufactured using an acrylic or novolac-based resist material and is capable of being formed by a photolithographic technique.

The liquid crystal display apparatus 10 may be produced by a printing technique or an ink jet technique using a material which is capable of being subjected to printing. In the liquid crystal display apparatus 10, the above structure preferably has adherence with respect to the upper and lower substrates. In the liquid crystal display apparatus 10, in cases where the upper substrate is attached to the lower substrate and where the liquid crystal is then enclosed therebetween, two inlets are formed. In cases where the liquid crystal is delivered by drops onto the substrate before the upper substrate is attached to the lower substrate and where the upper and lower substrates are then attached to each other, the inlets may not be formed.

In the liquid crystal display apparatus 10, spacers (not illustrated) are inserted into the liquid crystal layers to uniformly maintain cell gaps. Namely, in order to uniformly maintain the thickness, the cell gap in other words, of each of the liquid crystal layers, a spherical spacer made of a resin or an inorganic oxide is diffusively provided in the liquid crystal layer, and a plurality of structures such as column-like spacers are formed in the liquid crystal layer, thereby maintaining a predetermined cell gap. Preferably, each of the cell gaps in the liquid crystal layers has a size in the range from 3 μm≦d≦6 μm.

The scanning electrode driving circuit 14 is connected to the upper substrate 301 of each of the display devices, and the scanning electrode driving circuit 14 has a driver integrated circuit (IC) for the scanning electrodes 11a, this driver IC driving a plurality of the scanning electrodes 11a. The data electrode driving circuit 13 is connected to the lower substrate 305, and the data electrode driving circuit 13 has a driver integrated circuit (IC) for the data electrodes 11b, this driver IC driving a plurality of the data electrodes 11b. The data electrode driving circuit 13 and the scanning electrode driving circuit 14 respectively output a data signal and a scanning signal to a predetermined data electrode 11b and scanning electrode 11b on the basis of a predetermined signal output from the control circuit 15.

In the liquid crystal display apparatus 10, driving voltages of the B, G, and R liquid crystal layers are also capable of being configured so as to be substantially equal to each other, and therefore a predetermined output terminal of the scanning electrode driving circuit 14 is connected in common to a predetermined output terminal of each of the scanning electrodes 11a. Namely, the scanning electrode driving circuit 14 is not required to be provided for each of the B, G, and R display sections, and therefore the configuration of the driving circuit of the liquid crystal apparatus 10 is capable of being simplified. The output terminal of each of the B, G, and R scanning electrode driving circuits may have such an integrated configuration, where appropriate.

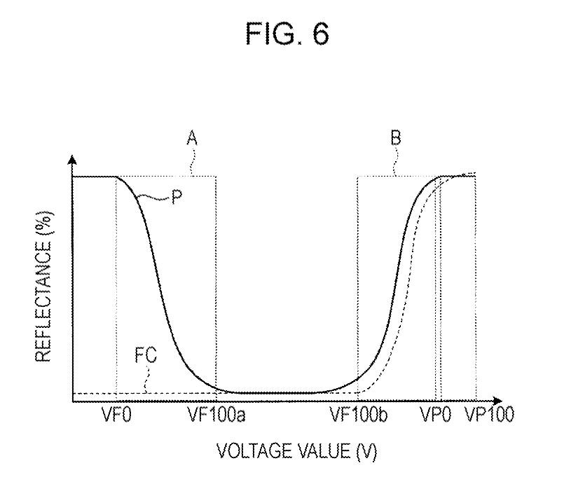

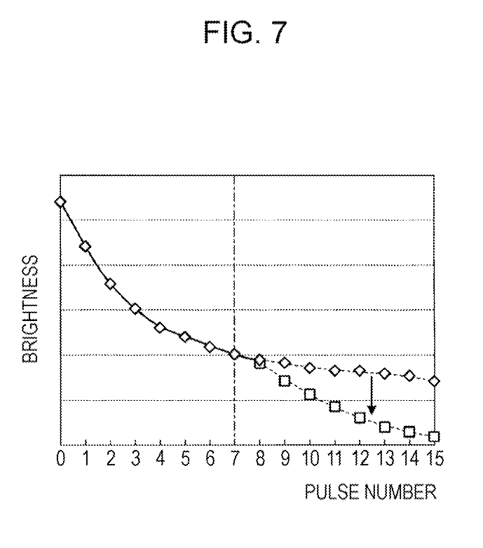

An example of a driving method of the liquid crystal display apparatus 10 will be described with reference to FIGS. 6 and 7. FIG. 6 illustrates an example of voltage-reflectance characteristics. FIG. 7 illustrates an example of the relationship between pulse number and brightness. In the liquid crystal display apparatus 10, a voltage pulse is cumulatively applied to the liquid crystal in the pixel, and cumulative response characteristics of the cholesteric liquid crystal are utilized to decrease brightness, thereby providing multiple-tone display. Each time a pulse voltage having a predetermined voltage value is applied to the cholesteric liquid crystal, a proportion in which a focal conic state exists is capable of being increased by utilizing the cumulative response characteristics, thereby gradually transferring a state of the cholesteric liquid from the planar state to the focal conic state.

In FIG. 6, a horizontal axis indicates a voltage value (V) of a pulse voltage that is applied between the two electrodes at a predetermined pulse duration (for example, 4.0 ms), the two electrodes interposing the cholesteric liquid crystal therebetween. A vertical axis indicates the reflectance (%) of the cholesteric liquid crystal. In FIG. 6, a solid curve P indicates the voltage-reflectance characteristics of the cholesteric liquid crystal having the initial state as the planar state, and a dashed curve FC indicates the voltage-reflectance characteristics of the cholesteric liquid crystal having the initial state as the focal conic state.

With reference to FIG. 6, a predetermined high voltage VP100 (for example, ±36 V) is applied between the two electrodes to generate a relatively strong electric field in the cholesteric liquid crystal with the result that the helical structures of liquid crystal molecules are completely canceled, thereby providing a homeotropic state in which all the liquid crystal molecules align in a direction of the electric field. The applied voltage is markedly decreased from VP100 to 0 V or to a predetermined low voltage (for example, VF0=±4 V) when the liquid crystal molecules are in the homeotropic state, thereby reducing the electric field to approximately zero. Then, each of the liquid molecules is in a state in which a helical axis aligns in a vertical direction with respect to the two electrodes and is therefore in a planar state in which light having a wavelength corresponding to a helical pitch is selectively reflected.

With reference to the curve P in a square A indicated by a dashed line in FIG. 6, the reflectance in the cholesteric liquid crystal is capable of being decreased with increasing voltage value (V) of the pulse voltage applied between the two electrodes. With reference to the curves P and FC in a square B indicated by a dashed line in FIG. 6, the reflectance in the cholesteric liquid crystal is capable of being increased with increasing voltage value (V) of the pulse voltage applied between the two electrodes.

The relationship between pulse number and brightness will be described with reference to FIG. 7. In FIG. 7, the horizontal axis indicates the number of applied voltage pulses, and the vertical axis indicates brightness. Characteristics of the liquid crystal display devices of the liquid crystal display apparatus 10 are represented by a curve that connects rhombic symbols in the pulse numbers from 0 to 7 and are represented by a curve that connects square symbols in the pulse numbers from 8 to 15. Responsiveness with respect to pulses is lower at the low tone side (represented by the square symbols) relative to the high tone side (represented by the rhombic symbols), and therefore a long pulse duration is employed at the high tone side.

For example, in the liquid crystal display apparatus 10, assume that the pulse duration is 1 in cases where the pulse number of the voltage pulse is in the range from 0 to 7 and that the pulse duration is 3 in cases where the pulse number of the voltage pulse is in the range from 8 to 15. Namely, in cases where the pulse duration is kept at 1, responsiveness to the pulses is low in the pulse numbers from 8 to 15 as indicated by the curve that connects the rhombic symbols in FIG. 7, and therefore variation in brightness is small.

On the other hand, in the liquid crystal display apparatus 10, the pulse duration is 1 in cases where the pulse number of the voltage pulse is in the range from 0 to 7, and the pulse duration is increased to 3 in cases where the pulse number of the voltage pulse is in the range from 8 to 15. Accordingly, as indicated by the curve that connects the rhombic symbols in the pulse numbers from 0 to 7 and as indicated by the curve that connects the square symbols in the pulse numbers from 8 to 15 in FIG. 7, brightness is appropriately capable of being varied. In the liquid crystal display apparatus 10, voltages applied to pixels of the individual B, G, and R display sections are controlled by utilizing characteristics of the above reset process and writing process, thereby enabling the color display to be provided.

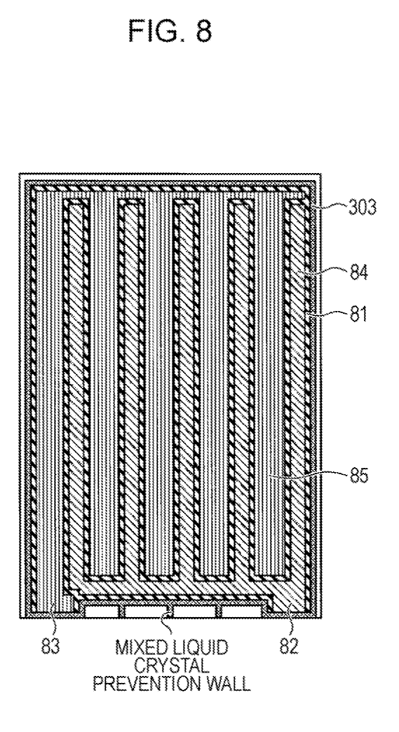

An example of production of the liquid crystal display device will be described with reference to FIG. 8. FIG. 8 illustrates the production of the liquid crystal display device. Two PC film substrates are prepared so as to each have a length of 10 cm and a width of 8 cm, and IZO transparent electrodes are formed on the PC film substrates. The IZO transparent electrodes are patterned by etching to provide strip-shaped electrodes of a 0.24 mm pitch. For example, the strip-shaped electrodes are configured so as to have widths of 0.07 mm, interelectrode gaps of 0.015 mm, other widths of 0.14 mm, and other interelectrode gaps of 0.015 mm, thereby providing a 0.24 mm pitch, and the strip-shaped electrodes are configured so as to have widths of 0.225 mm and interelectrode gaps of 0.015 mm, thereby providing a 0.24 mm pitch.

In order to provide a QVGA display of 320×240 dots, two sets of 320 stripe-shaped electrodes or a set of 320 and 240 stripe-shaped electrodes are individually formed on the two PC film substrates. Subsequently, the substrates on which the electrodes are formed are washed, and then polyimide films are applied as orientation films to the washed substrates so as to each have a thickness of 500 Å. Then, the resultant substrates are sintered at a temperature of 150° C. for an hour. Subsequently, the resultant substrates are subjected to rubbing with rayon cloth. The rubbing is performed such that directions of the rubbing in the individual substrates orthogonally intersect each other (cross rubbing) when the substrates are stacked so as to face each other.

Subsequently, a photoresist is applied onto the one PC film substrate, and then a resist is patterned through a photolithography process. The resultant product is sintered at a temperature of 150° C. for 120 minutes. With these processes, a structure 81 having a shape illustrated in FIG. 8 and having a height of 5 μm is produced. In cases where the two substrates are stacked, the structure 81 functions as a separation wall that separates two liquid crystal layers from each other, the two liquid crystal layers individually exhibiting selectivity for different reflection wavelengths.

Subsequently, the epoxy sealing members 303 are applied to the peripheries of the other PC film substrate by using a dispenser. Then, the two PC film substrates are attached to each other and then are sintered at a temperature of 160° C. for an hour while being pressed at a pressure of 1 kg/cm². With these processes, the sealing members 303 cure and adhere to the two PC film substrates. In addition, the structure 81 is also simultaneously attached to the two PC film substrates.

Subsequently, G cholesteric liquid crystal and B cholesteric liquid crystal is respectively vacuum-injected from a G inlet 82 and a B inlet 83. Then, the epoxy sealing members are used to seal the G inlet 82 and the B inlet 83, thereby producing a liquid crystal display device having a G reflecting layer 84 and a B reflecting layer 85. Similarly, a liquid crystal display device having an R reflecting layer and a B reflecting layer is produced. In this case, the liquid crystal display devices have the electrodes and separation walls having the same design. The two liquid crystal display devices are stacked while being displaced, thereby providing the pixel arrangement illustrated in FIG. 2. Helical directions of the R liquid crystal and the B liquid crystal are set so as to be opposite to that of the G liquid crystal. The dielectric constant anisotropy (Δ∈) of the liquid crystal is configured so as to satisfy the relationship of B liquid crystal>G liquid crystal>R liquid crystal. Specifically, the B liquid crystal is configured so as to have a Δ∈ value of 26, and the G liquid crystal is configured so as to have a Δ∈ value of 20, and the R liquid crystal is configured so as to have a Δ∈ value of 15.

### Advantageous Effect of First Embodiment

As described above, the liquid crystal display apparatus 10 has the display sections. In the display sections, the display devices in which liquid crystal materials are enclosed are stacked to form a two-layered structure, the liquid crystal materials reflecting light having a predetermined wavelength. In the display sections, two types of the liquid crystal materials are enclosed in at least any one of the two display devices that are stacked to form the two-layered structure, the two types of the liquid crystal materials individually exhibiting selectivity for different reflection wavelengths. The liquid crystal display apparatus 10 has the first layered liquid crystal display device 11A and the second layered liquid crystal display device 11B. The first and second layered liquid crystal display devices 11A and 11B are stacked to form the two-layered structure and have the liquid crystal materials that are enclosed inside the substrates and that reflect light having a predetermined wavelength. In the liquid crystal display apparatus 10, the individual liquid crystal materials enclosed in at least any one of the liquid crystal display devices reflect light so as to exhibit selectivity for two types of the reflection wavelengths, the liquid crystal display devices being stacked to form the two-layered structure. Accordingly, the number of the liquid crystal display devices to be stacked is configured to be two, thereby obtaining an advantageous effect of reduced production costs.

According to the first embodiment, the liquid crystal materials enclosed in any one of the liquid crystal display devices, which are stacked to form the two-layered structure, reflect light so as to exhibit selectivity for any two types of the reflection wavelengths selected from red, green, and blue. Accordingly, color display is sufficiently capable of being performed in the liquid crystal display apparatus having the two-layered structure and utilizing three types of the liquid crystal.

According to the first embodiment, in the liquid crystal display devices that are stacked to form the two-layered structure, the pixels that exhibit the selectivity for different types of the reflection wavelengths between the liquid crystal display devices have areas that are approximately twice as large as those of the pixels that exhibit the selectivity for the same type of the reflection wavelength between the liquid crystal display devices. Accordingly, red, green, and blue light beams are capable of being reflected in the same region, thereby easily adjusting a color balance.

Furthermore, according to the first embodiment, in the liquid crystal display devices that are stacked to form the two-layered structure, the liquid crystal materials enclosed in the liquid crystal display devices reflect light so as to exhibit the selectivity for the reflection wavelengths corresponding to the combination of blue and green or the combination of blue and red. Accordingly, color display is capable of being performed in the liquid crystal display apparatus having the two-layered structure.

Furthermore, according to the first embodiment, in the liquid crystal display devices that are stacked to form the two-layered structure, the liquid crystal display devices to be stacked have pixels of green or red having areas that are approximately twice as large as those of pixels of blue. Accordingly, red, green, and blue light beams are capable of being reflected in the same region, thereby easily adjusting a color balance.

Furthermore, according to the first embodiment, in the liquid crystal display devices that are stacked to form the two-layered structure, the dielectric constant anisotropy of the liquid crystal material that exhibits the selectivity for a short reflection wavelength is larger than that of the liquid crystal material that exhibits the selectivity for a long reflection wavelength. Accordingly, a voltage difference is capable of being decreased in every color. Also in cases where two types of liquid crystal that individually exhibit the selectivity for the different types of reflection wavelengths are enclosed in a single layer having an approximately uniform cell gap, driving voltages are capable of being configured to be equal to each other.

Furthermore, according to the first embodiment, the liquid crystal materials enclosed in any one of the liquid crystal display devices that are stacked to form the two-layered structure reflect light so as to exhibit selectivity for any two types of the reflection wavelengths selected from red, green, and blue. A helical direction in the liquid crystal material that exhibits the selectivity for the reflection wavelength corresponding to green is different from that in the liquid crystal material that exhibits the selectivity for the reflection wavelength corresponding to blue or red. Accordingly, in cases where the liquid crystal display devices are stacked, utilization efficiency of light is improved, thereby improving brightness.

Furthermore, according to the first embodiment, the liquid crystal display devices, which are stacked to form the two-layered structure, have the same electrode configurations. Furthermore, the liquid crystal display devices are stacked while being displaced at a predetermined degree. Accordingly, the stack structure according to the embodiment of the invention is capable of being provided such that each of the two liquid crystal display devices has the same design in the electrode configuration and other component.

Furthermore, according to the first embodiment, a light absorption layer is provided at the bottom of the liquid crystal devices that are stacked to form the two-layered structure, thereby providing excellent black color display.

Furthermore, according to the first embodiment, the liquid crystal materials employ the cholesteric liquid crystal. Accordingly, the selectivity for the reflection wavelength is relatively easily adjusted using the cholesteric liquid crystal.

### Second Embodiment

In the first embodiment, the liquid crystal materials, which are enclosed in any of the liquid crystal display devices that are stacked to form the two-layered structure, reflect light beams having two types of the wavelengths, but the embodiment is not limited to such a configuration. The two types of the liquid crystal materials may be arranged in an inverted manner in every pixel.

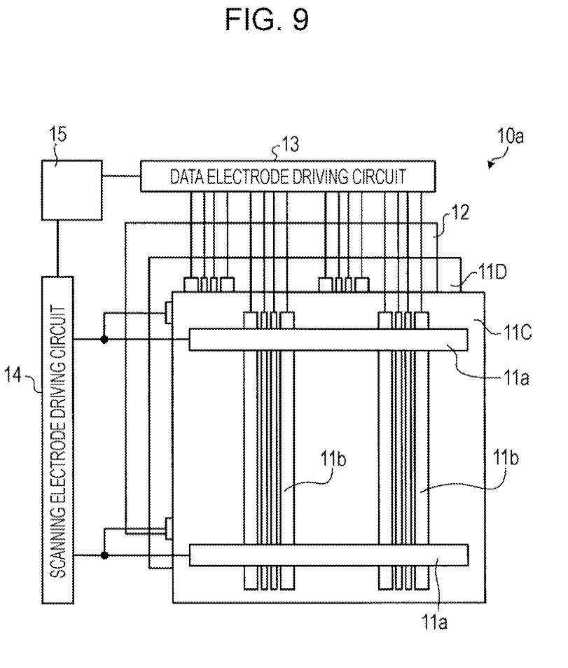

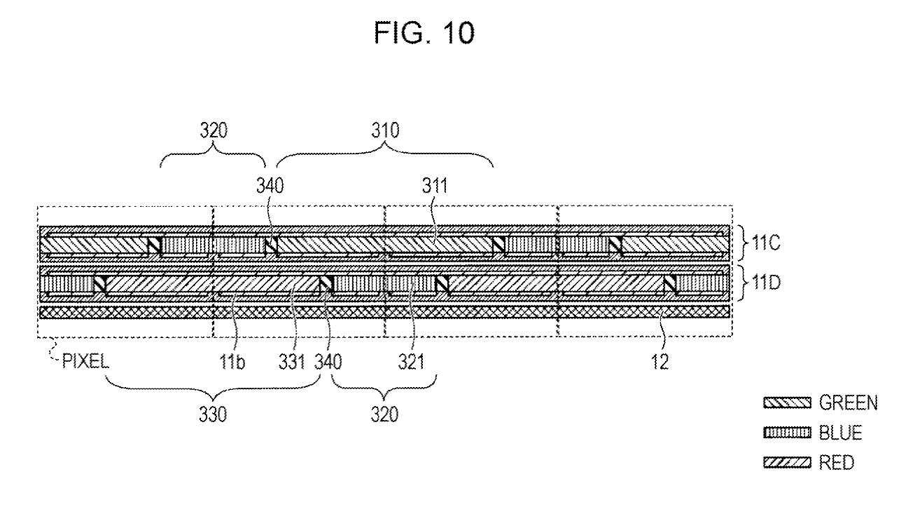

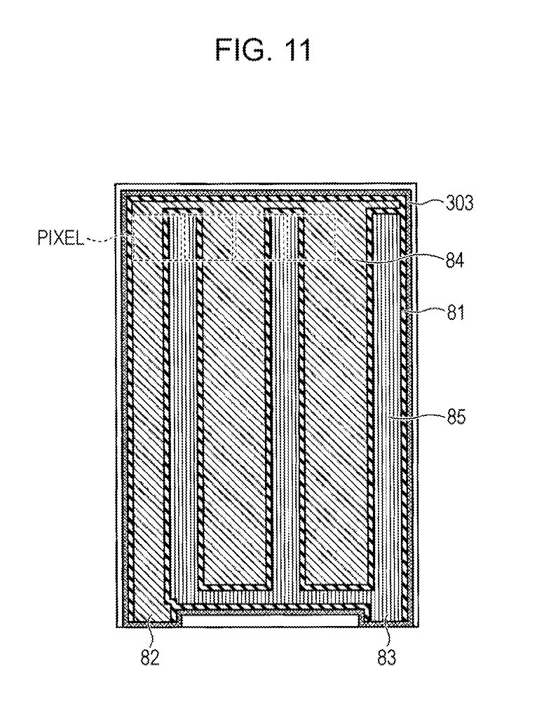

In the following second embodiment, with reference to FIGS. 9 to 11, the liquid crystal display apparatus 10a according to the second embodiment will be described as an example, in which two types of the liquid crystal materials are arranged in the inverted manner in every pixel. FIG. 9 schematically illustrates an example of the configuration of the liquid crystal display apparatus 10a according to the second embodiment. FIG. 10 illustrates an example of the cross-sectional configuration of the liquid crystal display device 10a. FIG. 11 illustrates production of the liquid crystal display device 10a.

First, the configuration of the liquid crystal display apparatus 10a according to the second embodiment will be described with reference to FIGS. 9 and 10. With reference to FIG. 9, as in the case of the liquid crystal display apparatus 10 illustrated in FIG. 1, two display devices (first layered liquid crystal display device 11C and second layered liquid crystal display device 11D) are stacked in the liquid crystal display apparatus 10a. At least one of the liquid crystal display devices exhibits the selectivity for two types of the reflection wavelengths. The liquid crystal display apparatus 10a has a configuration in which the first layered liquid crystal display device 11C and the second layered liquid crystal display device 11D are stacked in sequence.

The first layered liquid crystal display device 11C has a G display section 310 and a B display section 320, the G display section 310 including a G liquid crystal layer 311 that reflects green light in a planar state, and the B display section 320 including a B liquid crystal layer 321 that reflects blue light in the planar state. Moreover, the first layered liquid crystal display device 11A has a separation wall 340 that separates the G liquid crystal layer 311 from the B liquid crystal layer 321.

The second layered liquid crystal display device 11D has the B display section 320 and an R display section 330, the B display section 320 including the B liquid crystal layer 321 that reflects the blue light in a planar state, and the R display section 330 including an R liquid crystal layer 331 that reflects red light in the planar state. Moreover, the second layered liquid crystal display device 11B has a separation wall 340 that separates the B liquid crystal layer 321 from the R liquid crystal layer 331.

With reference to FIG. 10, a difference between the liquid crystal display devices of the liquid crystal display apparatus 10a and those of the liquid crystal display apparatus 10 illustrated in FIG. 1 is that two types of the liquid crystal layers are arranged in the inverted manner in every pixel. Specifically, in the liquid crystal display apparatus 10a, the two types of the liquid crystal layers exhibit the selectivity for different types of the reflection wavelengths and are arranged in the inverted manner in every pixel as illustrated in FIG. 10.

With reference to FIG. 10, the first layered liquid crystal display device 11C has the G liquid crystal layer 311 and the B liquid crystal layer 321 that are arranged in the inverted manner in every pixel, and the second layered liquid crystal display device 11D has the B liquid crystal layer 321 and the R liquid crystal layer 331 that are arranged in the inverted manner in every pixel. In addition, in the liquid crystal display apparatus 10a, the separation walls 340 are provided inside the display devices to separate different types of liquid crystal layers from each other.

Accordingly, in the liquid crystal display apparatus 10a, the separation walls 340 are capable of being configured so as to have widths (area) that are half of those of the liquid crystal display devices illustrated in FIG. 3. Therefore, mixed liquid crystal due to removal and failure of the separation walls 340 is suppressed, thereby increasing manufacturability. In cases where the mixed liquid crystal due to removal and failure of the separation walls 340 occurs, defective display may be caused.

Returning to FIG. 9, the liquid crystal display apparatus 10a has the scanning electrodes 11a and the data electrodes 11b as in the case of the liquid crystal display apparatus 10 illustrated in FIG. 1. In the first layered liquid crystal display device 11C, the liquid crystal layers are arranged in the inverted manner in every pixel, and therefore the electrodes are formed on the basis of the inverted arrangement of the liquid crystal layers.

An example of the production of the liquid crystal display devices according to the second embodiment will be described with reference to FIG. 11. In the liquid crystal display device according to the second embodiment, the separation walls 81 are continuously provided inside the display device such that adjacent liquid crystal layers are arranged in the inverted manner in every pixel, thereby separating liquid crystal regions of the G reflecting layer 84 from liquid crystal regions of the B reflecting layer 85. The liquid crystal regions are divided into two areas, and liquid crystal is injected into each of the G inlet 82 and the B inlet 83. Then, the inlets are sealed.

As described above, according to the second embodiment, the liquid crystal display apparatus 10a has the two types of liquid crystal that individually exhibit the selectivity for the different reflection wavelengths and that are arranged in the inverted manner in every pixel. Therefore, the separation walls are capable of being configured so as to have half widths (areas) relative to the widths of the separation walls in the first embodiment with the result that the mixed liquid crystal due to the removal and failure of the separation walls is suppressed, thereby increasing manufacturability.

### Third Embodiment

The embodiments of the invention have been described, but embodiments of the invention may be variously put into practice except the above embodiments. Accordingly, another embodiment of the invention will be described as a third embodiment.

### 1. Liquid Crystal Material

Although the liquid crystal material employs the cholesteric liquid crystal in the first embodiment, the embodiment is not limited to such a configuration. The liquid crystal material may employ chiral nematic liquid crystal. The chiral nematic liquid crystal is used, and the selectivity for the reflection wavelength is capable of being relatively easily adjusted.

### 2. Liquid Crystal Display Device

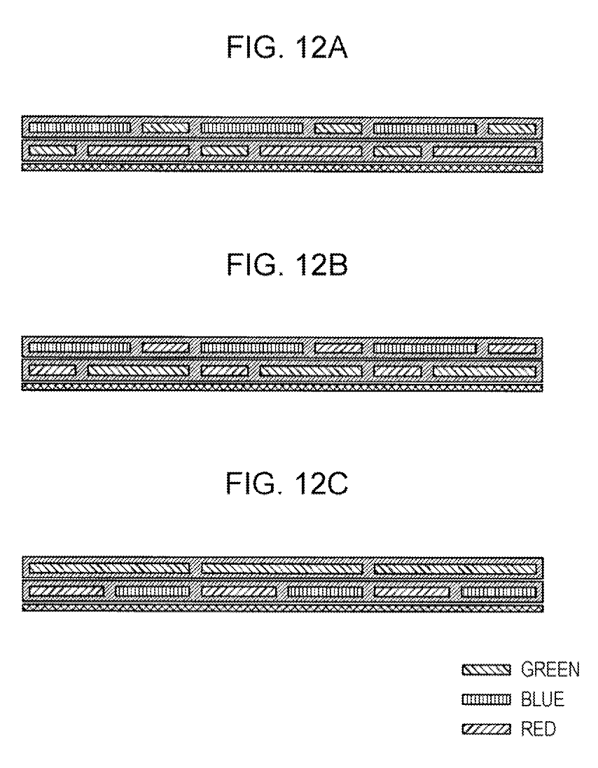

The embodiment is not limited to an example in which the liquid crystal materials are arranged in the liquid crystal display devices that forms the two-layered structure and that have been described in the first and second embodiments. For example, in the liquid crystal devices, the liquid crystal materials may be arranged as illustrated in FIGS. 12A, to 12C. For example, in FIG. 12A, the first layered liquid crystal display device has a blue liquid crystal layer and a green liquid crystal layer, and the blue liquid crystal layer has pixel areas that are twice as large as those of the green liquid crystal layer. Furthermore, the second layered liquid crystal display device has the green liquid crystal layer and a red liquid crystal layer, and the red liquid crystal layer has pixel areas that are twice as large as those of the green liquid crystal layer.

Furthermore, in FIG. 12B, the first layered liquid crystal display device has the blue liquid crystal layer and the red liquid crystal layer, and the blue liquid crystal layer has pixel areas that are twice as large as those of the red liquid crystal layer. The second layered liquid crystal display device has the red liquid crystal layer and the green liquid crystal layer, and the green liquid crystal layer has pixel areas that are twice as large as those of the red liquid crystal layer. Furthermore, in FIG. 12C, the first layered liquid crystal display device has only the green liquid crystal layers. The second layered liquid crystal display device has the red liquid crystal layers and the blue liquid crystal layers, and the pixel areas of the blue liquid crystal layers have sizes that are equal to those of the pixel areas of the red liquid crystal layers.

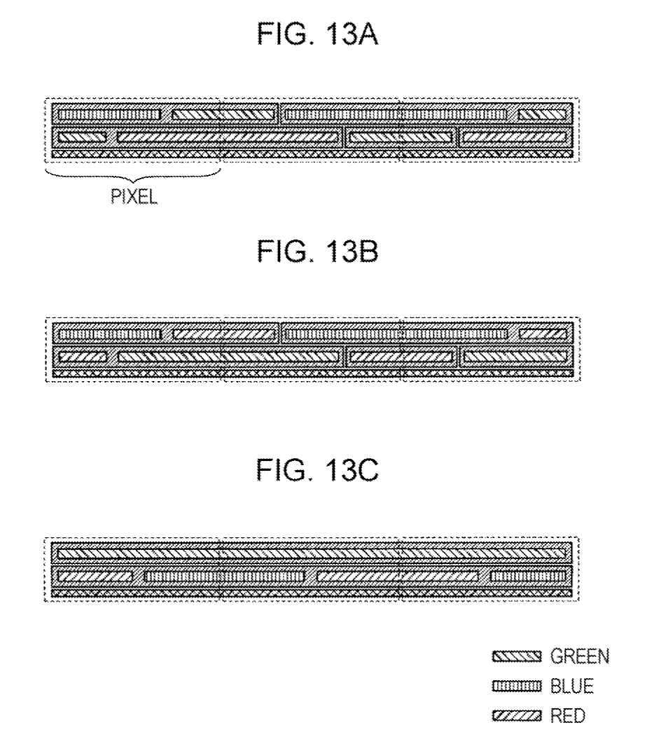

As an example of the liquid crystal display device in which two types of the liquid materials are arranged in the inverted manner in every pixel, the liquid materials may be arranged as illustrated in FIGS. 13A to 13C. For example, in FIG. 13A, the first layered liquid crystal display device has the blue liquid crystal layers and the green liquid crystal layers, and the blue liquid crystal layers have pixel areas that are twice as large as those of the green liquid crystal layers. Furthermore, the second layered liquid crystal display device has the green liquid crystal layers and the red liquid crystal layers, and the red liquid crystal layers have pixel areas that are twice as large as those of the green liquid crystal layers.

Furthermore, in FIG. 13B, the first layered liquid crystal display device has the blue liquid crystal layers and the red liquid crystal layers, and the blue liquid crystal layers have pixel areas that are twice as large as those of the red liquid crystal layers. The second layered liquid crystal display device has the red liquid crystal layers and the green liquid crystal layers, and the green liquid crystal layers have pixel areas that are twice as large as those of the red liquid crystal layers. Furthermore, in FIG. 13C, the first layered liquid crystal display device has only the green liquid crystal layers. The second layered liquid crystal display device has the red liquid crystal layers and the blue liquid crystal layers, and the pixel areas of the blue liquid crystal layers have sizes that are equal to those of the pixel areas of the red liquid crystal layers.

### 3. Inlet

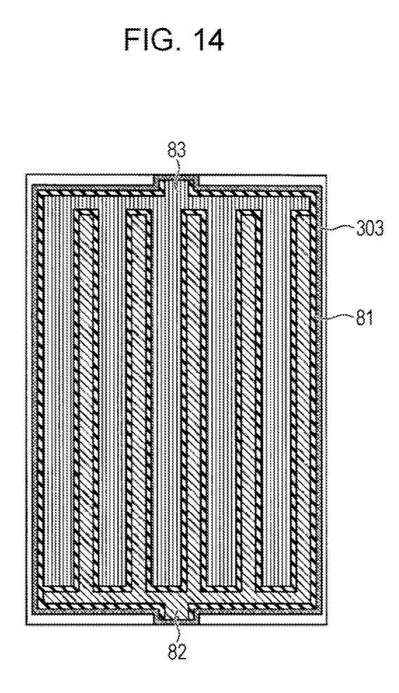

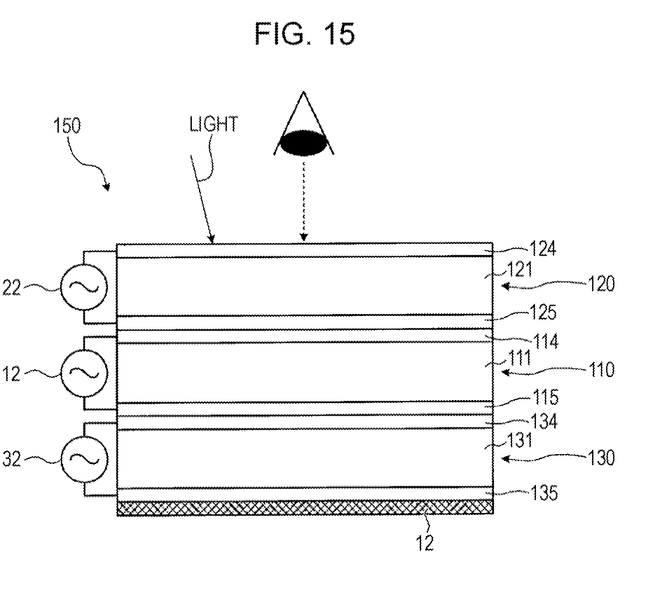

In the first and second embodiments, the examples have been described, in which the inlets are provided at the left and right sides of the liquid crystal display devices to inject the two types of liquid crystal (see, FIGS. 8 and 11). However, the embodiment is not limited to such a configuration. For example, the inlets may be provided at the upper and lower sides of the liquid crystal display devices to inject the two types of liquid crystal as illustrated in FIG. 14.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A liquid crystal display apparatus comprising:
a plurality of pixels, each of the pixels including:
a first liquid crystal display device including a first region for reflecting a light of a first reflection wavelength band and a second region for reflecting a light of a second reflection wavelength band, and
a second liquid crystal display device including a third region for reflecting a light of a third reflection wavelength band and a fourth region for reflecting a light of a fourth reflection wavelength band, the second liquid crystal display device being stacked over the first liquid crystal display device.

2. The liquid crystal display apparatus according to claim 1, wherein
the first, the second and the third reflection wavelength bands are different from each other, and
the first reflection wavelength band is the same as the fourth reflection wavelength band.

3. The liquid crystal display apparatus according to claim 2, wherein
the first reflection wavelength band corresponds to a blue light,
the second reflection wavelength band corresponds a red light, and
the third reflection wavelength band corresponds to a green light.

4. The liquid crystal display apparatus according to claim 1, wherein
an area of the second region is twice as large as an area of the first region, and
an area of the third region is twice as large as an area of the fourth region.

5. The liquid crystal display apparatus according to claim 3, wherein
a dielectric constant anisotropy of a first liquid crystal material in the first region is greater than a dielectric constant anisotropy of a third liquid crystal material in the third region, and
the dielectric constant anisotropy of the third liquid crystal material is greater than a dielectric constant anisotropy of a second liquid crystal material in the second region.

6. The liquid crystal display apparatus according to claim 5, wherein
a helical direction in the third liquid crystal material is different from
a helical direction in the first or the second liquid crystal material.

7. The liquid crystal display apparatus according to claim 1, wherein
the third region is placed over the first region and one part of the second region, and
the fourth region is placed over another part of the second region.

8. The liquid crystal display apparatus according to claim 7, wherein
an arrangement of the first region and the second region is reversed in neighboring pixels.

9. The liquid crystal display apparatus according to claim 1, further comprising:
a visible light absorption layer provided at the bottom of the plurality of pixels.

10. The liquid crystal display apparatus according to claim 1, wherein
a liquid crystal material of the first and the second liquid crystal display devices is cholesteric liquid crystal or chiral nematic liquid crystal.
